(19) United States
(12) Patent Application Publication
(10) Pub. No.: US 2014/0208541 A1
(43) Pub. Date: Jul. 31, 2014

(54) SELF-STERILIZING DOOR HANDLE

(71) Applicant: Derek Cowburn, McCordsville, IN (US)

(72) Inventor: Derek Cowburn, McCordsville, IN (US)

(21) Appl. No.: 14/149,782

(22) Filed: Jan. 7, 2014

Related U.S. Application Data
(60) Provisional application No. 61/749,700, filed on Jan. 7, 2013.

(51) Int. Cl. B25G 1/00; B08B 7/04

(52) U.S. Cl. CPC B25G 1/00; B08B 7/04
USPC 16/110.1

(57) ABSTRACT

A system, comprising: a handle including a first portion and a second portion; a housing configured to: expose at least part of the first portion and conceal at least part of the second portion when the handle is in a first state; and expose at least part of the second portion and conceal at least part of the first portion when the handle is in a second state; and a sterilizing source disposed within the housing and configured to substantially sterilizing a portion of the handle concealed by the housing in at least one of the first state and the second state.

### BACKGROUND

This disclosure relates to door handles and, in particular, self-sterilizing door handles.

Door handles may aid in transmission of pathogens between individuals. Some door handles may attempt to sanitize the door handle using ultraviolet (UV) light. However, the UV light is directed towards the handle in such a way that a user, and in particular, a user's eyes may be exposed to the UV light. In addition, the intensity of UV light may be reduced to a level to attempt to improve safety, but the lower intensity is insufficient to sanitize the door handle. In addition, door handles including materials that may sanitize over time may take longer than a time between which users may contact the handle.

### SUMMARY

An embodiment includes a system, comprising: a handle including a first portion and a second portion; a housing configured to: expose at least part of the first portion and conceal at least part of the second portion when the handle is in a first state; and expose at least part of the second portion and conceal at least part of the first portion when the handle is in a second state; and a sterilizing source disposed within the housing and configured to substantially sterilizing a portion of the handle concealed by the housing in at least one of the first state and the second state.

### BRIEF DESCRIPTION OF SEVERAL VIEWS OF THE DRAWINGS

FIG. 1 is a perspective view of a door handle according to an embodiment.

FIG. 2 is a perspective view of a door with a door handle according to an embodiment.

FIG. 3 is a perspective view of a door handle with a portion illustrated offset according to an embodiment.

FIG. 4 is a perspective view of a door with a door handle according to another embodiment

FIGS. 5-6 are diagrams illustrating multiple door handles according to some embodiments.

FIGS. 7-9 are diagrams illustrating a door handle according to another embodiment.

### DETAILED DESCRIPTION

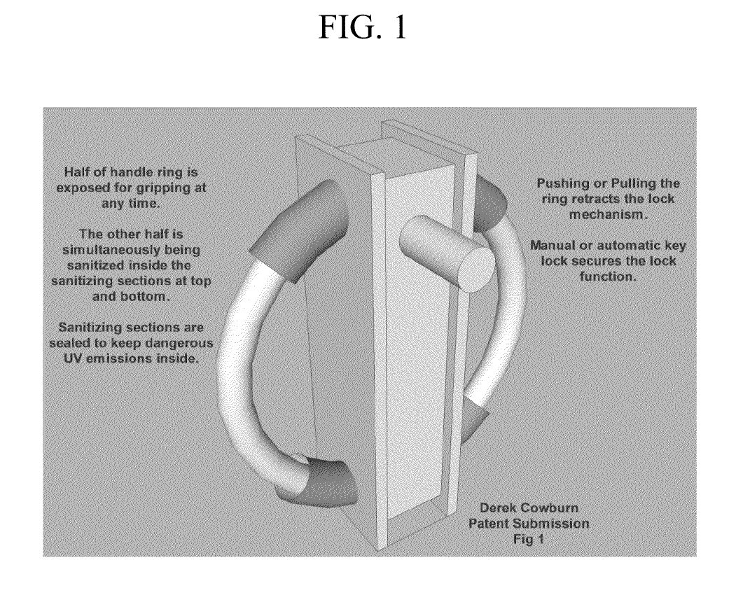

FIG. 1 is a perspective view of a door handle according to an embodiment.

In an embodiment, a handle may be disposed in a housing. The housing may substantially conceal at least a part of the handle. In this embodiment, the handle is a ring shape. The ring can rotate through the housing. Within the housing may be a sterilizing source. The sterilizing source may be a UV light or alternate sterilizing agent.

Accordingly, eyes and other products may be protected from harmful UV sterilizing light source. As described in further detail below, UV light may have harmful effects.

In an embodiment, an indicator light shows when sterilization is complete on the exposed handle section after being rotated to the exposed position.

Due to the housing concealing the portion of the handle that is being sterilized, much brighter UV light may be used for sterilization. Accordingly, a greater degree of sterilization and/or faster cycle times may be achieved.

In an embodiment, when not being contacted, the handle may move to cycle between sterile and non-treated zones. Modern, appealing aesthetics.

In this embodiment, the handle may be configured to be pulled or pushed to unlatch and open. The handle may be configured to move in the housing to move a portion into the housing to be sterilized and move another portion out of the housing to be available as a sterilized surface. For example, as the ring is pushed or pulled, the ring may rotate about ¼ inch into the housing. Over use, the handle will rotate through the housing. Although a used portion may not complete sterilize the entire handle each cycle, the amount of sterilization may be sufficient. However, in other embodiments, the handle may be configured to move such that an entire exposed portion is moved to be within the housing to be sterilized after one push/pull action.

In an embodiment, at least a portion of the handle is accessible, even when other portions are being sterilized.

In an embodiment, movement is accomplished without motors and may not foul over time. That it, the movement of the handle when pushing, pulling, rotating, or the like may provide the force to move an exposed portion of the handle to pass through the housing to be sterilized. For example, the handle may be moved using a spring that was preloaded by the motion of the handle by a user.

In an embodiment, the handle may be installed in standard 2-hole door configurations.

In an embodiment, electric power can be provided through the door jamb. Powered cycle may occur during a closed door condition. A battery can provide temporary power during open state. Locking can be automated or manual (keyed).

Although approximately one half of the handle is exposed, different ratios of exposed area to concealed area may be used. Moreover, different housings may expose different portions and conceal other portions. Regardless, portions of the handle that have been contacted may be moved into the housing such that the sterilizing source may substantially sterilize the portion of the handle.

In an embodiment, at least a portion of the door handle is accessible at all times.

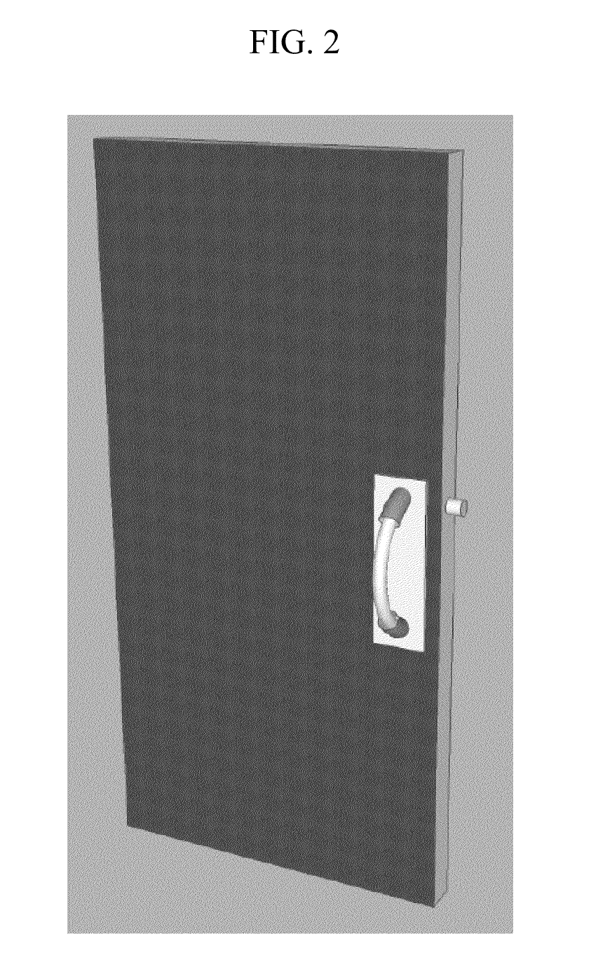

FIG. 2 is a perspective view of a door with a door handle according to an embodiment. In this embodiment, the system of FIG. 1 is illustrated installed in a single door. However, in other embodiments, the system may be installed in a double door. In another embodiment, the system may be installed in a sliding door. In another embodiment, the system may be installed in a switch. For example, the switch may move through a housing similar to the handle described above.

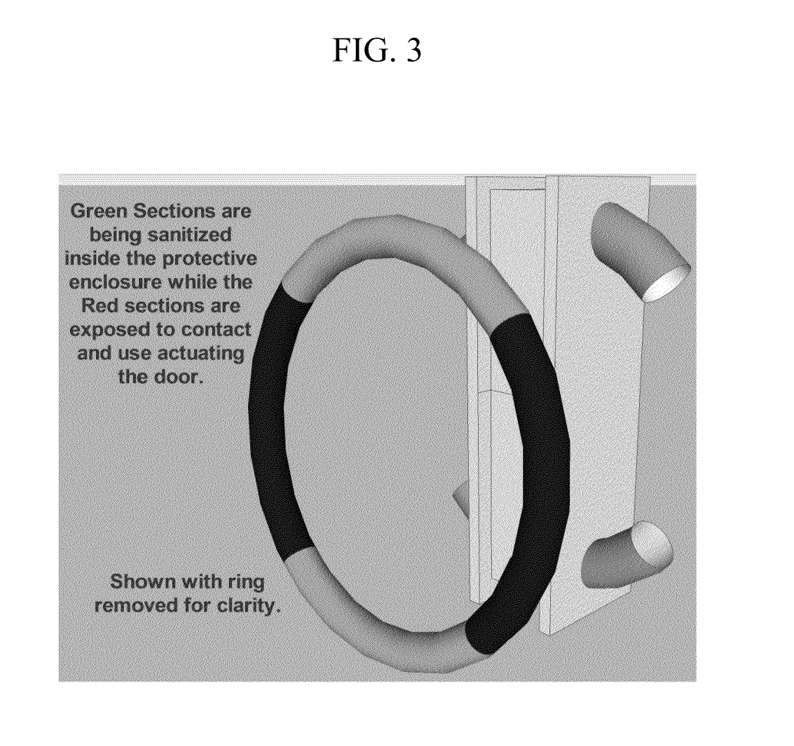

FIG. 3 is a perspective view of a door handle with a portion illustrated offset according to an embodiment. The ring is illustrated with two different shadings. One shaded portion would be within the housing while the differently shaded portion would be outside of the housing and accessible to a user.

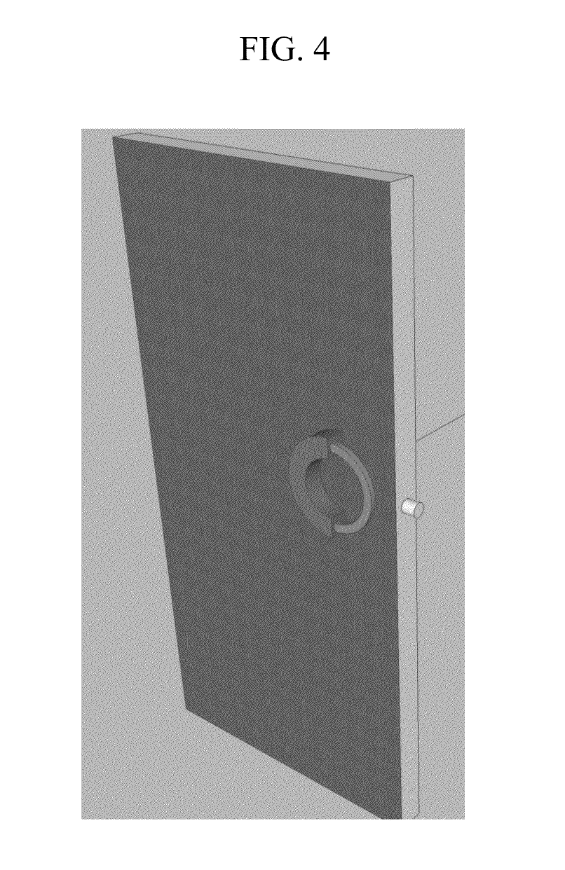

FIG. 4 is a perspective view of a door with a door handle according to another embodiment. In this embodiment, the ring may still rotate, however, the rotation is cause by a pushing or pulling action on the exposed portion of the handle.

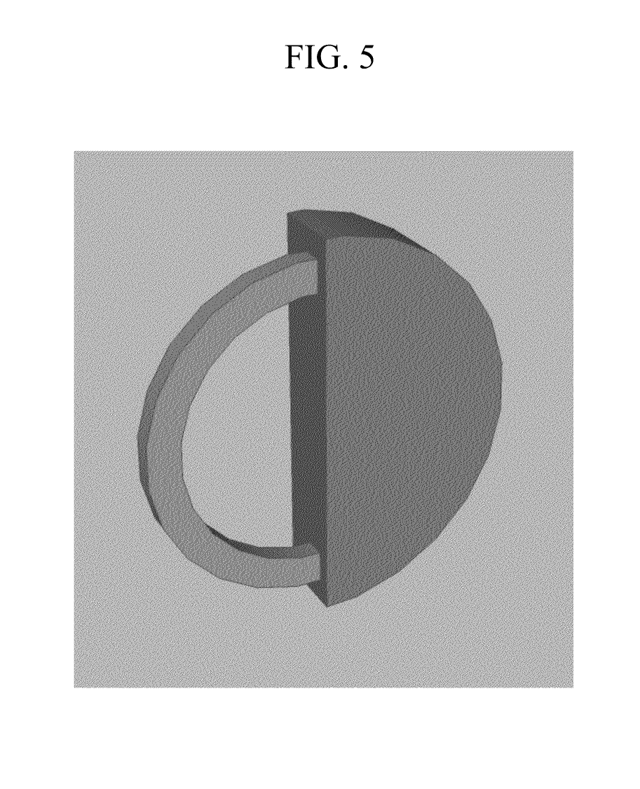

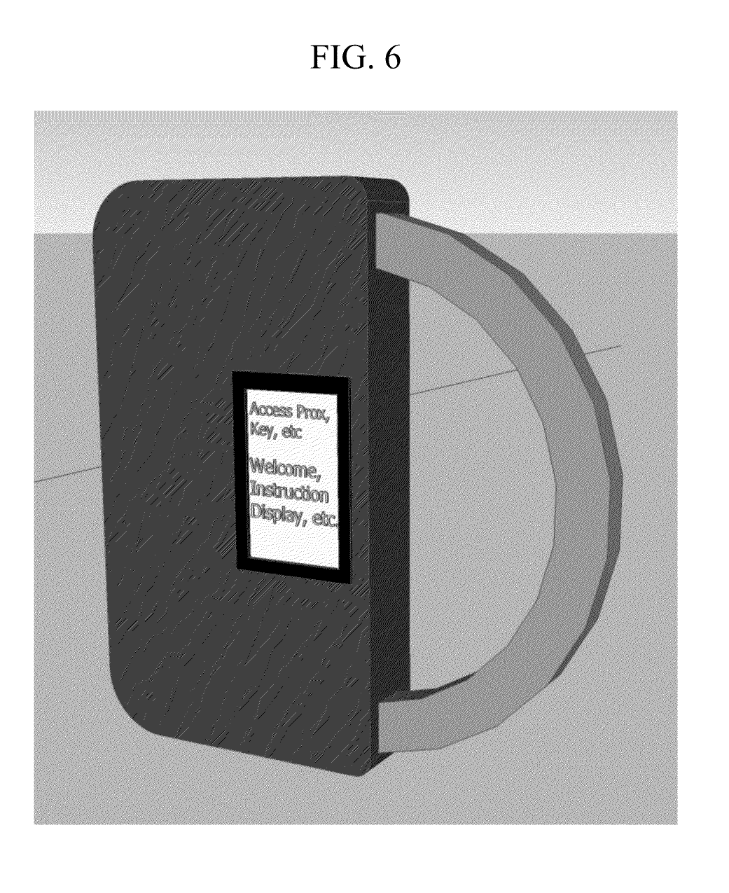

FIGS. 5-6 are diagrams illustrating multiple door handles according to some embodiments. In FIG. 5 the exposed portion of the handle may be on different sides of the system.

In FIG. 6, a user interface may be disposed on the housing. The user interface may include a display. The user interface may be configured to inform a user of the state of sterilization, a time until sterilization has occurred, general notification, operation instruction, or the like.

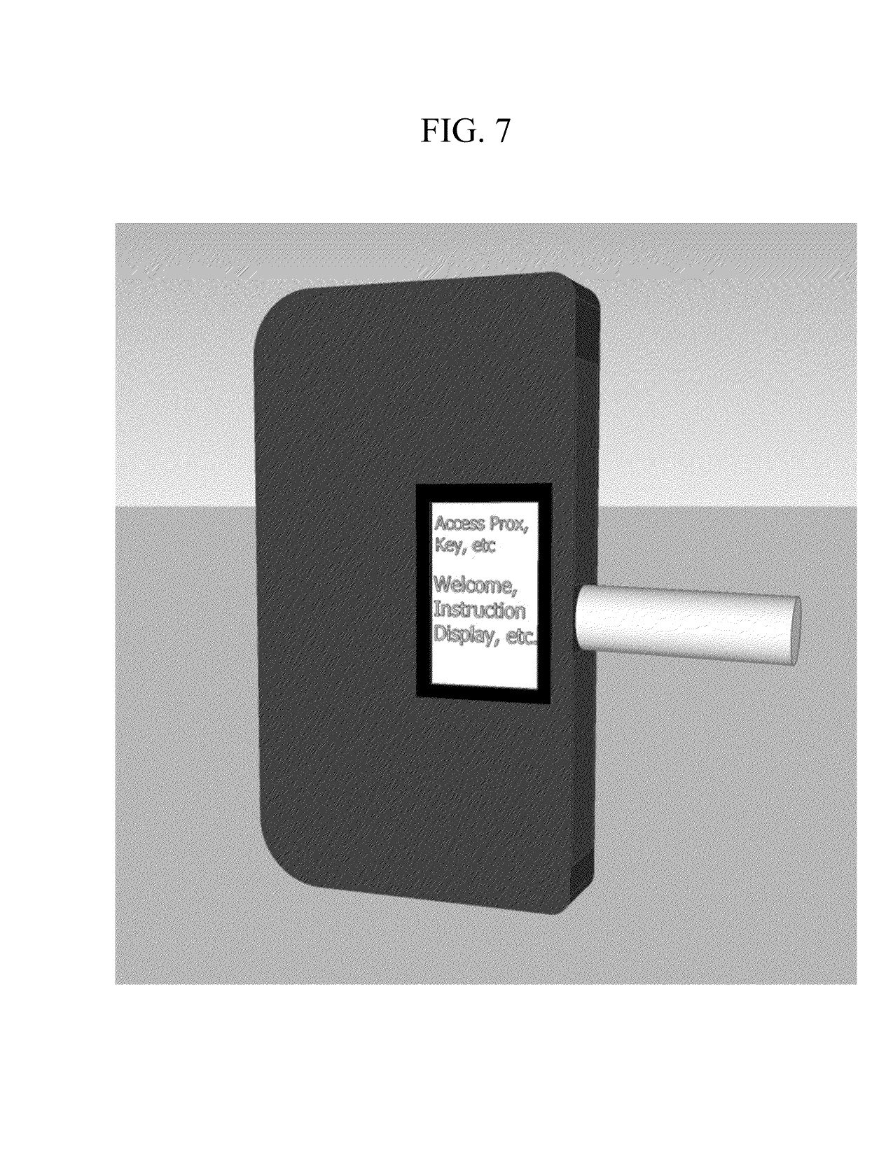

FIGS. 7-9 are diagrams illustrating a door handle according to another embodiment. In this embodiment, the handle may include multiple spokes. One spoke may be substantially exposed. Another spoke may be substantially concealed within the housing. Accordingly, while one spoke of the handle may be used to actuate a door or other system, the other spoke may be sterilized. Although two spokes have been illustrated, any number may be present. For example, in a particular embodiment, three spokes may be substantially equidistantly angularly distributed around the handle. Although the spoke has been illustrated as being disposed on the handle at a 90 degree angle, the spokes may be disposed at different angles.

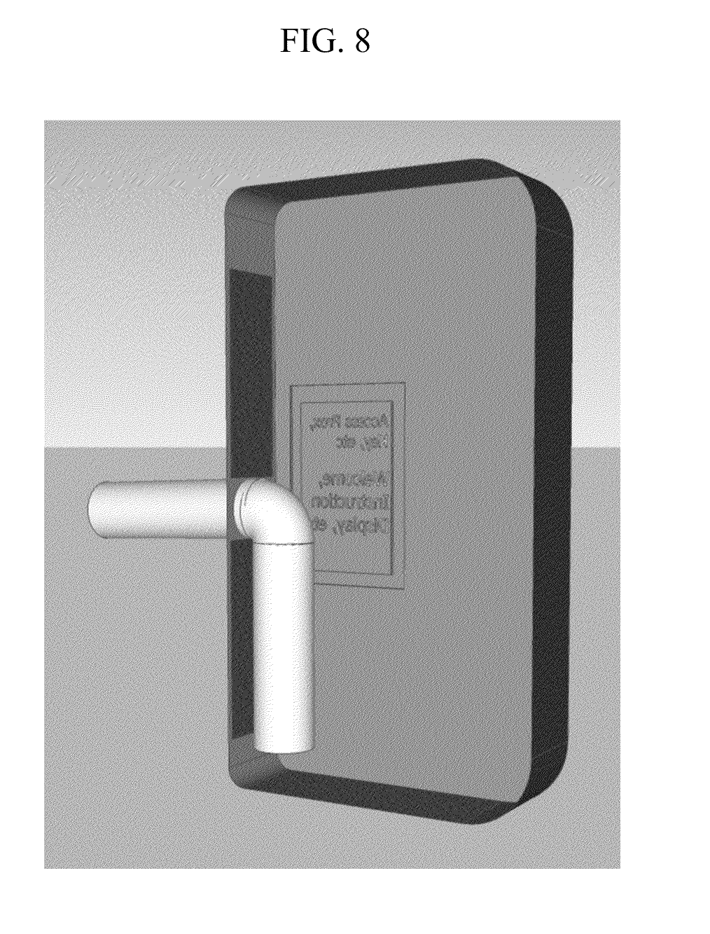

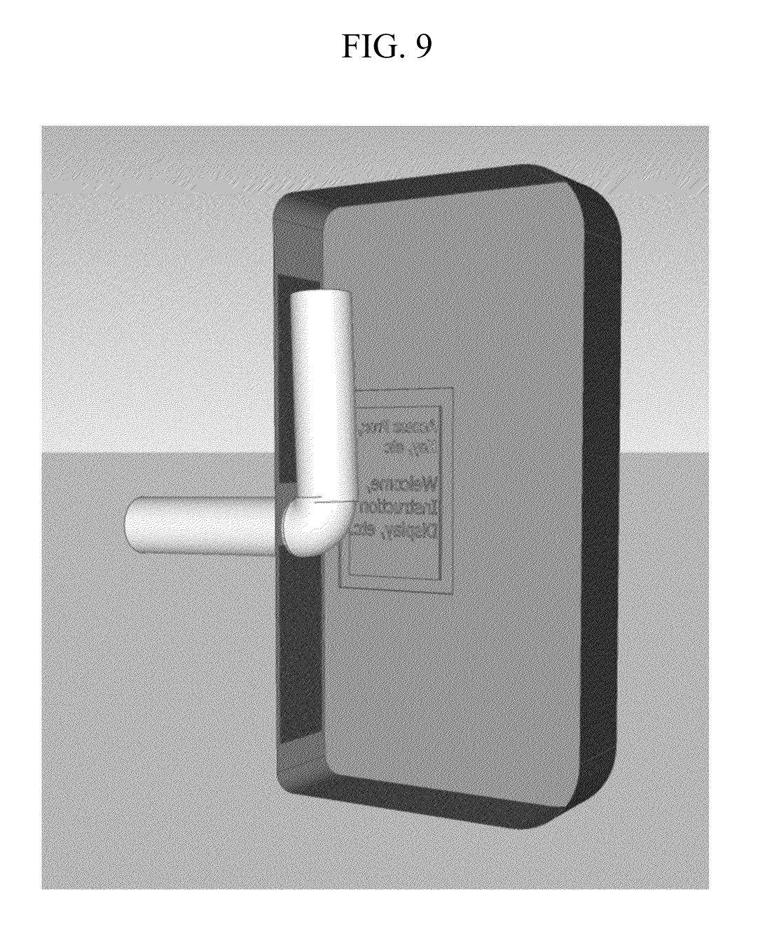

In an embodiment, the spokes may rotate through the housing. However in other embodiments, the spokes may toggle back and forth. FIGS. 8 and 9 illustrate two different states of the handle where different spokes are exposed or concealed.

In an embodiment, doors of the housing may substantially conceal a spoke within the housing. As the handle is moved, as illustrated in FIGS. 8 and 9, the doors may open to allow the exposed handle to enter the housing and the sterilized spoke to exit the housing. The doors may close afterwards so that the spoke within the housing is substantially concealed and may be sterilized.

In another embodiment, the system may be installed as a user interface. For example, a user interface may include a joystick, spoke, or other control. After the user is finished, the spoke or other control may be moved into a housing and replaced with another. For example, a pointing device, such as a trackball, a stick, switch, button, or the like maybe configured to have multiple portions that may be actuated by a user, but some portions are concealed by the housing and may be sterilized.

Prior UV Sterilization techniques for door handles require exposed UV sources or movable hood covers that get in the way of accessing the handle. These exposed UV rays are dangerous for humans.

In an embodiment, only half of the ring handle is exposed for gripping at any time while the other half is being sterilized from all angles safely inside the top and bottom retaining sections of the ring holding mechanism. Pushing the ring toward the door or pulling it from the door will release the door latch mechanism (when locking mechanism is not engaged). Ring rotation may be achieved by piezo motors and trolley-cog pads (one way motion) to avoid gook build-up on rotating wheels. Ring may be locked into position after a motion cycle so a hand does not rotate it causing an uneasy feel. That is, in an embodiment, the handle may not rotate freely in the users hand but may move some amount and then provide some if not substantial resistance.

In an embodiment, a control processor may senses capacitive touch (or other touch detection) on the ring and keeps the ring locked and rotating motion deactivated. The ring or handle begins the rotation and sterilization process upon release. Lock may be charged or powered from the door jamb via contact pads. A battery may be disposed in the housing, in the door, or the like. The battery may operate the electronics in the lock. The UV light may be powered when the door is in the closed or open position. The battery may run the UV light but will have limited cycles before needing recharge. Control circuit restricts operation of UV if insufficient charge remaining to operate the indication and sensing functions. Contact with the door handle may set the indicator light to “dirty” indication. “clean” indication may be accomplished after handle has completed a sterilization cycle and rotated the clean sections into position. The lock can also be powered via the hinges or flexible whip connection. All DC operation may be under 40 W so can be powered through and communicated with a system using only, for example, a Cat5 wire to the door. A wired or wireless communication interface allows communication with building management for lock cycles, cleaning schedule, battery condition, lock/unlock state and command.

In an embodiment, assembly of the ring may be completed in sections and secured with internal set screws or neodymium magnets. Ring cannot be removed due to angle of sanitizing/retaining section. In an embodiment, the exposed portion of the ring may be substantially continuous. As a result, any joining portions, such as the set screws or magnets, or the like, may be substantially concealed by the housing. As a result, an opportunity for tampering with the door may be reduced. Orientation can be vertical or horizontal. Mechanical operation can be push in/out or up/down to release lock latch and/or bolt.

UV-C Germicidal Bulbs & Germicidal Lamps Germicidal lamps(UVGI/UV-C) are mainly used in specialized sterilization processes. UV-C gives off light at the short end of wavelength that is harmful to micro-organisms 253.7 nm. UV-C lamps are used in air purification, aquarium and pond sterilization, water purification and some etching processes. Germicidal UVC lamps are clear in appearance and have no phosphor on the inner portion of the glass. Another distinguishing aspect is that the germicidal arc tube is also made of quartz glass rather than standard fluorescent glass. This allows UV light to pass freely through the envelope and onto a surface. Types of Germicidal Lamps: Low Pressure Mercury Arc Tubes: Most Germicidal lamps are Low Pressure Mercury Arc Lamps. These lamps are available in Ozone producing or Non-Ozone producing. The peak wavelength for the non-ozone producing germicidal lamp is 253.7 nm and the peak wavelength for ozone producing Germicidal lamps is 253.7 nm and 185 nm. Medium Pressure Arc Lamps: These type lamps are much more similar to the High Intensity Discharge(HID) lamp. They produce a broad band of UV-C radiation unlike the Low Pressure which radiates one band. The main use of these type lamps is in industrial and commercial waste water purification plants. Here large doses of intense radiation must be produced to ensure clean water that is free from micro-organisms and any contamination. UV-C is Dangerous At this wavelength (253.7 nm) germicidal lamps are dangerous to humans or any other forms of life it may come in contact with. The lamp should be shielded and should not be view able to the naked eye. If exposed to germicidal wavelengths humans will notice a sunburn on their skin and some may begin the initial stages of skin cancer. If a persons eyes are exposed to UVC lamps the individual will notice a severely painful inflammation of the cornea which may lead to temporary or permanent vision loss or impairment. Germicidal lamps are also known as UV lamps, UV-C lamps, UVC bulbs, germicidal lamps, TUV lamps, germicidal UV light, UV Bulbs, UV-C Light Source, germicidal bulb. GERMICIDAL SAFETY SHEET PLEASE READ BEFORE USING LAMP G4T5, G6T5, G8T5, G15T8, G20T10, G25T8, G30T8, G40T10, G64T5, GTL-3, PL-S13/TUV, PL-L18/TUV, PL-L36/TUV HEALTH EFFECTS DANGER: These lamps emit ULTRAVIOLET RADIATION (UVC).

UV lights have various instructions for safety: For example, ultraviolet radiation is harmful to the skin and the eyes and can cause serious skin burns and eye injury either from direct or reflected radiation. To reduce the risk of personal injury, install only in a fixture which provides adequate protection to area occupants. Hand and eye protection should be worn at all times when handling. Precautions for safe handling and use: Consult the fixture manufacturer regarding the suitability of the fixture for this lamp. Operate with proper auxiliary equipment. Turn off lamps before installing, replacing, cleaning or performing any maintenance work near the fixtures. Handle lamps carefully to avoid breakage. Broken glass can cause cuts. Waste disposal method: At the end of rated life, when this lamp is removed from service it will be subjected to the current Toxic Characteristic Leaching Procedure (TCLP) prescribed by the Environmental Protection Agency. This test is used in determining whether an item is a hazardous waste or a non-hazardous waste under current EPA definition. These lamps would fail the TCLP test and would be considered hazardous waste under the Universal Waste Rules. Generators should evaluate all of the disposal options, which may be available in the particular state in which the generator's facility is located. The generator should check with federal, state and local officials for their guidance. In some embodiments, UV lights, such as those described above, may be used as sterilizing sources.

Although a sterilizing source, such as the UV light, may be capable of substantially sterilizing a portion of the handle, in some embodiment, the sterilization may, but need not be complete before the portion of the handle is moved to be exposed. An indicator may indicate whether the sterilization is complete.

Although various structures, methods, and systems have been described in above, other embodiments may include many variations, combinations, modifications or the like to the particular embodiments. Such variations, combinations, or the like should be considered to be within the spirit and scope of the structures, methods, and systems disclosed herein. Accordingly, many variations, combinations, modifications or the like may be made by one of ordinary skill in the art without departing from the spirit and scope of the appended claims.

1. A system, comprising:
a handle including a first portion and a second portion;
a housing configured to:
expose at least part of the first portion and conceal at least part of the second portion when the handle is in a first state; and
expose at least part of the second portion and conceal at least part of the first portion when the handle is in a second state; and
a sterilizing source disposed within the housing and configured to substantially sterilizing a portion of the handle concealed by the housing in at least one of the first state and the second state.
